(19) United States
(12) Patent Application Publication
(10) Pub. No.: US 2021/0018325 A1
(43) Pub. Date: Jan. 21, 2021

(54) VEHICLE COMMUNICATION DEVICE AND VEHICLE COMMUNICATION SYSTEM

(71) Applicant: TOYOTA JIDOSHA KABUSHIKI KAISHA, Toyota-shi (JP)

(72) Inventors: Masaki ITO, Toyota-shi (JP); Masashi MORI, Nagoya-shi (JP); Miyuki KUBOTA, Gotemba-shi (JP); Chiharu AOKI, Numazu-shi (JP); Nanami SANO, Susono-shi (JP); Daichi SAKAKIBARA, Susono-shi (JP)

(73) Assignee: TOYOTA JIDOSHA KABUSHIKI KAISHA, Toyota-shi (JP)

(21) Appl. No.: 16/919,845

(22) Filed: Jul. 2, 2020

(30) Foreign Application Priority Data
Jul. 18, 2019 (JP) 2019-133108

(51) Int. Cl. G01C 21/34; G06F 16/9035; G06F 16/9038; G06F 1/16

(52) U.S. Cl. CPC G01C 21/3484; G01C 21/3438; G06F 1/163; G06F 16/9038; G06F 16/9035

(57) ABSTRACT

A vehicle communication device incudes: an information creation unit that creates information related to a plurality of users based on pieces of personal information of the plurality of users held by wearable terminals when the plurality of users respectively wearing the wearable terminals ride on a vehicle; and an information display unit that displays the information created by the information creation unit on the wearable terminals worn by the plurality of users.

### CROSS-REFERENCE TO RELATED APPLICATION(S)

The present application claims priority to and incorporates by reference the entire contents of Japanese Patent Application No. 2019-133108 filed in Japan on Jul. 18, 2019.

### BACKGROUND

The present disclosure relates to a vehicle communication device and a vehicle communication system.

Japanese Laid-open Patent Publication No. 2001-053841 discloses a mobile terminal that displays biorhythms of a user and a registered communication partner. This mobile terminal calculates biorhythms including a body biorhythm, an emotion biorhythm, and a passion biorhythm of the user and the communication partner, and displays states of the biorhythms at the current time on a display unit. As a result, the user can take appropriate action over a phone according to display results of the biorhythms.

### SUMMARY

There is a need for providing a vehicle communication device and a vehicle communication system capable of constructing a vehicle interior space where each user can comfortably stay when a plurality of users ride on a vehicle together.

According to an embodiment, a vehicle communication device includes: an information creation unit that creates information related to a plurality of users based on pieces of personal information of the plurality of users held by wearable terminals when the plurality of users respectively wearing the wearable terminals ride on a vehicle; and an information display unit that displays the information created by the information creation unit on the wearable terminals worn by the plurality of users.

According to an embodiment, a vehicle communication system includes: a plurality of wearable terminals worn by a plurality of users; a detection unit that detects presence of the plurality of wearable terminals in a vehicle when the plurality of users ride on the vehicle; an information creation unit that creates information related to the plurality of users based on pieces of personal information of the plurality of users held by the wearable terminal; and an information display unit that displays the information created by the information creation unit on the wearable terminals worn by the plurality of users.

### BRIEF DESCRIPTION OF THE DRAWINGS

FIG. 1 is a block diagram schematically illustrating a vehicle communication system to which a vehicle communication device according to an embodiment of the present disclosure can be applied;

FIG. 2 is a flowchart illustrating a first example of a communication method executed by the vehicle communication system according to the embodiment of the present disclosure;

FIG. 3 is a flowchart illustrating a second example of the communication method executed by the vehicle communication system according to the embodiment of the present disclosure; and

FIG. 4 is a view illustrating an example of a case where compatibility information is displayed on a wearable terminal in the vehicle communication system according to the embodiment of the present disclosure.

### DETAILED DESCRIPTION

In the related art, people having no acquaintance with each other often ride on the same vehicle together in, for example, a ride sharing (sharing) service that has recently become popular. In this case, however, it is difficult for the passengers to talk to each other, and uncomfortable atmosphere may be created inside the vehicle.

A vehicle communication device and a vehicle communication system according to an embodiment will be described with reference to the accompanied drawings. Note that the components in the following embodiment include one that components be easily replaced by those skilled in the art or components that are substantially the same.

Vehicle Communication System

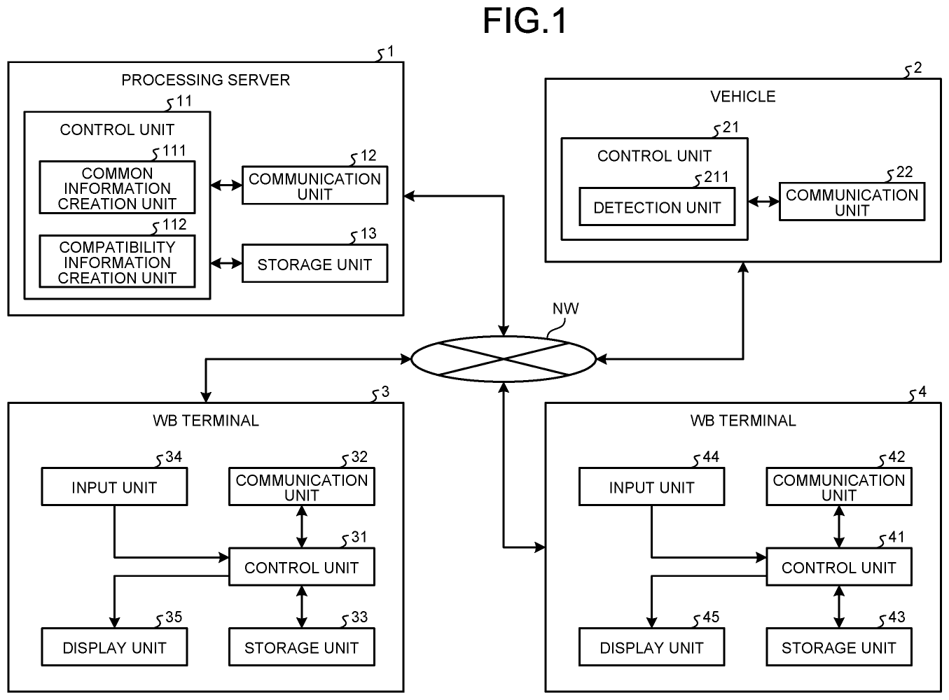

First, the vehicle communication system to which the vehicle communication device according to the embodiment is applied will be described with reference to FIG. 1. The vehicle communication system includes a processing server 1, a vehicle 2, and a plurality of wearable terminals (hereinafter, referred to as “WB terminals”) 3 and 4. The vehicle communication device according to the present embodiment is configured specifically using the processing server 1. The vehicle 2 constituting the vehicle communication system may be a single vehicle or a plurality of vehicles. In addition, three or more WB terminals may be used although the two WB terminals 3 and 4 are illustrated in the drawing.

The processing server 1, the vehicle 2, and the WB terminals 3 and 4 can communicate with each other via a network NW. This network NW includes, for example, the Internet network, a mobile phone network or the like.

Processing Server

Next, a configuration of the processing server 1 will be described with reference to FIG. 1. The processing server 1 processes information received from the WB terminals 3 and 4, and includes a control unit 11, a communication unit 12, and a storage unit 13.

The control unit 11 includes, specifically, a processor including a central processing unit (CPU), a digital signal processor (DSP), a field-programmable gate array (FPGA) and the like, and a memory (main storage unit) such as a random access memory (RAM) and read only memory (ROM) (none of which are illustrated).

The control unit 11 loads and executes a program stored in the storage unit 13 on a work area of the main storage unit, and controls each constituent unit through execution of the program, thereby implementing a function that meets a predetermined purpose. The control unit 11 functions as a common information creation unit 111 and a compatibility information creation unit 112 through the execution of the program. Note that details of the common information creation unit 111 and the compatibility information creation unit 112 will be described later.

The communication unit 12 includes, for example, a local area network (LAN) interface board, a wireless communication circuit for wireless communication and the like. The communication unit 12 is connected to a network NW such as the Internet which is a public communication network. Then, the communication unit 12 is connected to the network NW to perform communication between the processing server 1, and each of the vehicle 2 and the WB terminals 3 and 4.

The storage unit 13 includes a recording medium such as an erasable programmable ROM (EPROM), a hard disk drive (HDD), and a removable medium. Examples of the removable media include a universal serial bus (USB) memory, and a disc recording media such as compact disc (CD), a digital versatile disc (DVD), and a Blu-ray (registered trademark) disc (BD). In the storage unit 13, for example, detection information received from a detection unit 211 of the vehicle 2, personal information and biological information received from the WB terminals 3 and 4, common information created by the common information creation unit 111, compatibility information created by the compatibility information creation unit 112 and the like are temporarily stored.

Vehicle

Next, a configuration of the vehicle 2 will be described with reference to FIG. 1. The vehicle 2 is a mobile body that can communicate with the outside, and includes a control unit 21 and a communication unit 22. The control unit 21 is physically the same as the control unit 11 described above.

The control unit 21 comprehensively controls operations of various constituent elements mounted on the vehicle 2. The communication unit 22 includes, for example, a data communication module (DCM), and performs communication with the processing server 1 by wireless communication via the network NW.

WB Terminal

Examples of the WB terminals 3 and 4 include a glasses-type terminal, a wristband-type terminal, a clothes-type terminal, and the like. In the present embodiment, a description will be given assuming the glasses-type terminal. The WB terminals 3 and 4 can bidirectionally communicate with the processing server 1 via the network NW, and virtually display an image, a character, and the like in a viewing area while transmitting light in the viewing area.

The WB terminal 3 includes a control unit 31, a communication unit 32, a storage unit 33, an input unit 34, and a display unit 35. Similarly, the WB terminal 4 includes a control unit 41, a communication unit 42, a storage unit 43, an input unit 44, and a display unit 45. The control units 31 and 41, the communication units 32 and 42, and the storage units 33 and 43 are physically the same as the control unit 11, the communication unit 12, and the storage unit 13 described above.

The storage units 33 and 43 store personal information of users wearing the WB terminals 3 and 4. The personal information includes all kinds of information about a user, and examples thereof include access fields such as a name, an age, address, a date of birth, presence of lover, presence of spouse, a work place (work experience), a school name (educational background), and a hobby, behavior pattern information, a possessed qualification, a favorite type of opposite sex and the like.

The input units 34 and 44 include, for example, a physical button, a touch panel, a microphone and the like. The user wearing the WB terminal 3 operates the physical button or the touch panel, or make voice toward a speaker microphone to input predetermined information to the control units 31 and 41.

When the WB terminals 3 and 4 are the glasses-type terminals, the display units 35 and 45 include a liquid crystal display (LCD), an organic EL display (OLED) or the like provided in a lens of glasses. The display units 35 and 45 display the image, the character, and the like under the control of the control units 31 and 41.

Communication Method: First Example

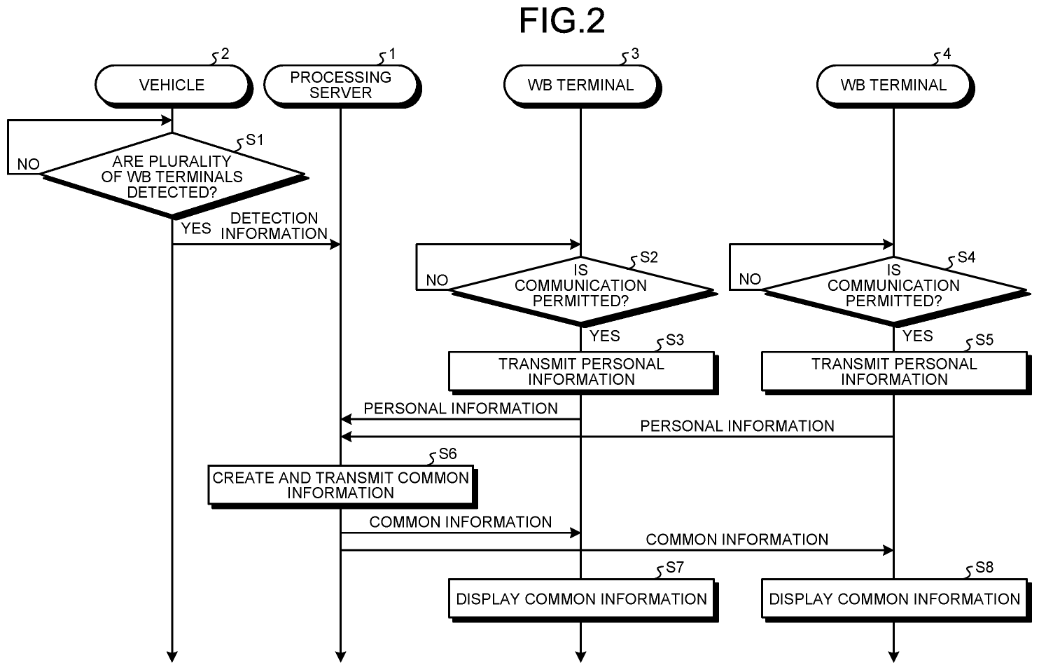

A first example of a communication method executed by the vehicle communication system will be described with reference to FIG. 2. Hereinafter, a description will be given assuming a situation, for example, where users respectively wearing the WB terminals 3 and 4 ride on the same vehicle 2 in the ride-sharing service. In addition, the users wearing the WB terminals 3 and 4 may be of the same sex or of opposite sexes.

First, the detection unit 211 of the vehicle 2 detects that the plurality of WB terminals 3 and 4 are present in the vehicle 2 (Step S1), and transmits such detection information to the processing server 1. Subsequently, the control unit 31 of the WB terminal 3 determines whether to permit the user wearing the WB terminal 3 to communicate with the user wearing the other WB terminal 4 in the vehicle 2 (Step S2).

In Step S2, the control unit 31 displays, for example, characters such as “do you permit communication with a fellow passenger?” on the display unit 35. Then, when the user having viewed this display inputs “accept” via the input unit 34, that is, by pressing the physical button or the touch panel or by inputting a voice to the microphone, the control unit 31 makes an affirmative determination (Yes in Step S2). Then, the control unit 31 transmits personal information of the user stored in the storage unit 33 to the processing server 1 (Step S3).

Note that the control unit 31 makes a negative determination (No in Step S2) and returns to the determination processing in Step S2 when the user having viewed the display on the display unit 35 inputs “not accept” via the input unit 34.

Subsequently, the control unit 41 of the WB terminal 4 determines whether to permit the user wearing the WB terminal 4 to communicate with the user wearing the other WB terminal 3 in the vehicle 2 (Step S4). Details of the processing in Step S4 are the same as those in Step S2, and thus, will not be described. Note that either Step S2 or Step S4 may be performed first, or the both may be performed simultaneously.

When an affirmative determination is made in Step S4 (Yes in Step S4), the control unit 41 transmits personal information of the user stored in the storage unit 43 to the processing server 1 (Step S5). On the other hand, when a negative determination is made in Step S4 (No in Step S4), the control unit 41 returns to the determination processing of Step S4.

Subsequently, the processing server 1 creates information related to the plurality of users based on pieces of the personal information of the plurality of users transmitted respectively from the WB terminals 3 and 4. In this case, the common information creation unit 111 of the processing server 1 compares the pieces of personal information of the plurality of users with each other to create common information indicating an item common to the plurality of users, and transmits the common information to the WB terminals 3 and 4 (Step S6).

Here, the common information refers to common information or similar information for the user wearing the WB terminal 3 and the user wearing the WB terminal 4 out of personal data, and examples thereof include the same family name or first name, the same age, close address, the same work place, the common work experience, the common educational background, the same hobby, the same possessed qualification and the like.

Subsequently, the display unit 35 of the WB terminal 3 displays the common information created by the common information creation unit 111 (Step S7). Similarly, the display unit 45 of the WB terminal 4 displays the common information created by the common information creation unit 111 (Step S8).

According to the communication method executed by the vehicle communication system as described above, an opportunity for the users to have a talk in the vehicle is created by displaying the common information created based on the personal information of each of the users on the respective WB terminals 3 and 4. As a result, a vehicle interior space where the plurality of users can comfortably stay is constructed. In addition, according to the present disclosure, the sense of resistance of each user can be reduced when users having no acquaintance ride on the same vehicle 2, which facilitates the popularization of the ride-sharing service.

Communication Method: Second Example

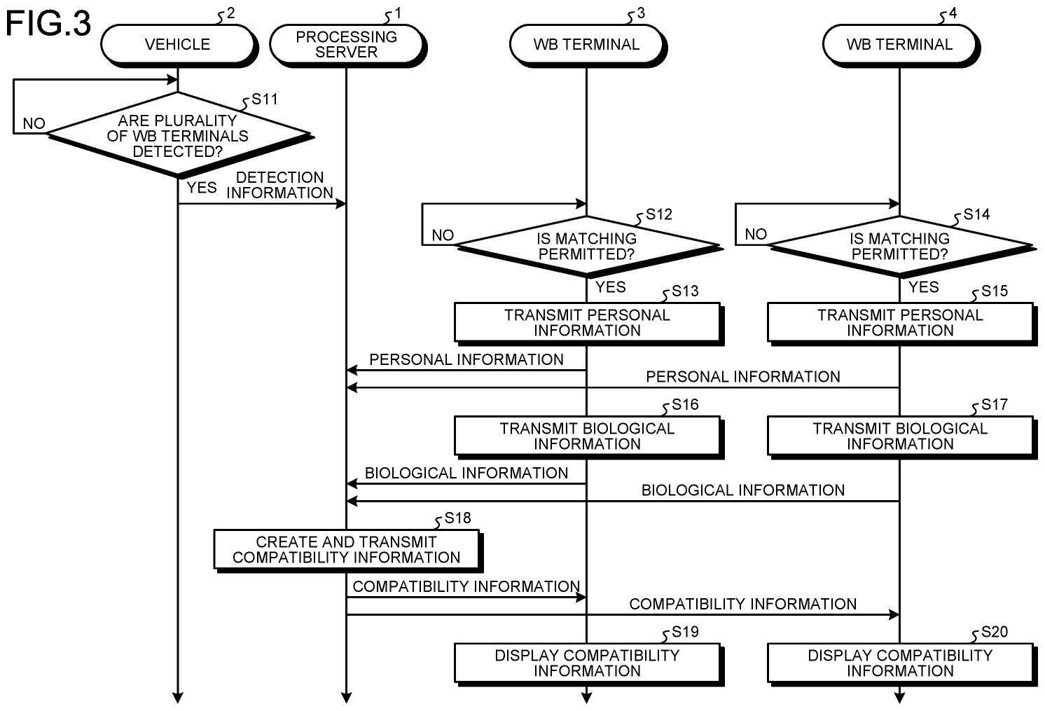

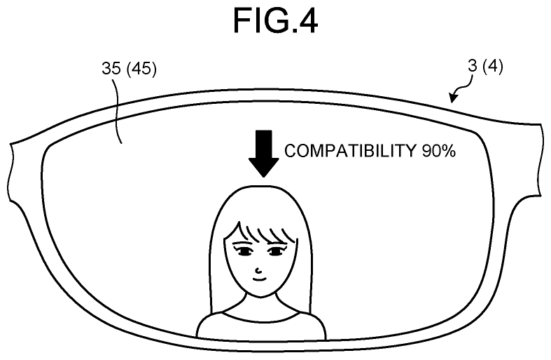

A second example of the communication method executed by the vehicle communication system will be described with reference to FIGS. 3 and 4. Hereinafter, a description will be given assuming a situation, for example, where users of opposite sexes respectively wearing the WB terminals 3 and 4 ride on the same vehicle 2 in the ride-sharing service.

First, the detection unit 211 of the vehicle 2 detects that the plurality of WB terminals 3 and 4 are present in the vehicle 2 (Step S11), and transmits such detection information to the processing server 1. Subsequently, the control unit 31 of the WB terminal 3 determines whether to permit the user wearing the WB terminal 3 to perform matching with the user wearing the other WB terminal 4 in the vehicle 2. (Step S12).

In Step S12, the control unit 31 displays, for example, characters such as “do you permit matching with a fellow passenger?” on the display unit 35. Then, when the user having viewed this display inputs “accept” via the input unit 34, that is, by pressing the physical button or the touch panel or by inputting a voice to the microphone, the control unit 31 makes an affirmative determination (Yes in Step S12). Then, the control unit 31 transmits personal information of the user stored in the storage unit 33 to the processing server 1 (Step S13).

Note that the control unit 31 makes a negative determination (No in Step S12) and returns to the determination processing in Step S12 when the user having viewed the display on the display unit 35 inputs “not accept” via the input unit 34.

Subsequently, the control unit 41 of the WB terminal 4 determines whether to permit the user wearing the WB terminal 4 to perform matching with the user wearing the other WB terminal 3 in the vehicle 2. (Step S14). Details of the processing in Step S14 are the same as those in Step S12, and thus, will not be described. Note that either Step S12 or Step S14 may be performed first, or the both may be performed simultaneously.

When an affirmative determination is made in Step S14 (Yes in Step S14), the control unit 41 transmits personal information of the user stored in the storage unit 43 to the processing server 1 (Step S15). On the other hand, when a negative determination is made in Step S14 (No in Step S14), the control unit 41 returns to the determination processing of Step S14.

Subsequently, the control unit 31 of the WB terminal 3 transmits biological information obtained from the user to the processing server 1 (Step S16). Similarly, the control unit 41 of the WB terminal 4 transmits biological information obtained from the user to the processing server (Step S17).

Here, the biological information refers to vital information that can be acquired by the WB terminals 3 and 4, such as a pulse, a body temperature, and a blood pressure. Since this biological information is acquired when a plurality of users are riding on the vehicle 2, changes in pulse, body temperature, blood pressure and the like, for example, when the users of opposite sexes are observing each other or having a talk are also acquired.

The biological information may be acquired by the WB terminals 3 and 4, or may be acquired by a wristband-type WB terminal separately worn by a user. In addition, the processing in Steps S16 and S17 described above is not essential, but it is possible to more accurately calculate the compatibility between users by creating compatibility information in consideration of the biological information (for example, changes in pulse, body temperature, blood pressure and the like) in addition to the personal information of each of the users.

Subsequently, the processing server 1 creates information related to the plurality of users based on pieces of the personal information and the biological information of the plurality of users transmitted respectively from the WB terminals 3 and 4. In this case, the compatibility information creation unit 112 of the processing server 1 creates the compatibility information indicating the compatibility between the plurality of users based on the relationship between the pieces of personal information of the plurality of users and the biological information, and transmits the compatibility information to the WB terminals 3 and 4 (Step S18). Here, the compatibility information refers to information indicating the compatibility between the plurality of users.

Subsequently, the display unit 35 of the WB terminal 3 displays the compatibility information created by the compatibility information creation unit 112 (Step S19). Similarly, the display unit 45 of the WB terminal 4 displays the compatibility information created by the compatibility information creation unit 112 (Step S20). For example, as illustrated in FIG. 4, the display units 35 and 45 can indicate the compatibility with another user in the vehicle 2 by a numerical value, or in a schematized manner using a graph or the like.

According to the communication method executed by the vehicle communication system as described above, an opportunity for the users of opposite sexes to interact with each other in the vehicle, for example, is created by displaying the compatibility information created based on the personal information of each of the users on the respective WB terminals 3 and 4. For example, when the compatibility with another user in the vehicle 2 is indicated by the numerical value as illustrated in FIG. 4, it becomes easier to talk to the user. As a result, a vehicle interior space where the plurality of users can comfortably stay is constructed. In addition, according to the present disclosure, the sense of resistance of each user can be reduced when users having no acquaintance ride on the same vehicle 2, which facilitates the popularization of the ride-sharing service.

As described above, the vehicle communication device and the vehicle communication system according to the present disclosure have been specifically described in the detailed description of the preferred embodiments. However, a gist of the present disclosure is not limited to these descriptions, and should be interpreted widely based on the description in the claims. In addition, it is a matter of course that various changes and modifications based on these descriptions are also included in the gist of the present disclosure.

Further effects and modifications can be easily derived by those skilled in the art. Accordingly, broader aspects of the present disclosure are not limited by the specific details and representative embodiments that are illustrated and described above. Therefore, various modifications can be made without departing from the sprit and scope of the general concept of the disclosure defined by the accompanying claims and the equivalent thereof.

For example, the pieces of the personal information of the respective users are stored in advance in the storage units 33 and 43 of the WB terminals 3 and 4 in the above-described embodiment, but may be stored in the storage unit 13 of the processing server 1 in advance.

In addition, the compatibility information of the respective users is created by the compatibility information creation unit 112 of the processing server 1 in the above-described embodiment, but may be created by the control units 31 and 41 of the WB terminals 3 and 4.

In addition, the description has been given in the above-described embodiment by dividing the example where the common information of the respective users is created and displayed on the WB terminals 3 and 4 (see FIG. 2) and the example where the compatibility information of the respective users is created and displayed on the WB terminals 3 and 4 (see FIG. 3), but both the common information and the compatibility information of the respective users may be created and displayed on the WB terminals 3 and 4.

According to the present disclosure, the opportunity for users to have a talk in the vehicle is created, whereby the vehicle interior space where the plurality of users can comfortably stay is constructed. In addition, according to the present disclosure, the sense of resistance of each user can be reduced when users having no acquaintance ride on the same vehicle, which facilitates the popularization of the ride-sharing service.

According to an embodiment, the vehicle communication device displays the information created based on the personal information of each of the users on the respective wearable terminals, thereby creating an opportunity for the users to have a talk in the vehicle is created.

According to an embodiment, the vehicle communication device displays the common information created based on the personal information of each of the users on the respective wearable terminals, thereby creating the opportunity for the users to have a talk in the vehicle.

According to an embodiment, the vehicle communication device displays the compatibility information created based on the personal information of each of the users on the respective wearable terminals, thereby creating an opportunity for users of opposite sexes to interact with each other in the vehicle, for example.

According to an embodiment, the vehicle communication device can calculate the compatibility between the users with higher accuracy by creating the compatibility information in consideration of the biological information in addition to the personal information of each of the users.

According to an embodiment, the vehicle communication system displays the information created based on the personal information of each of the users on the respective wearable terminals, thereby creating the opportunity for the users to have a talk in the vehicle is created.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle communication device comprising:
an information creation unit that creates information related to a plurality of users based on pieces of personal information of the plurality of users held by wearable terminals when the plurality of users respectively wearing the wearable terminals ride on a vehicle; and
an information display unit that displays the information created by the information creation unit on the wearable terminals worn by the plurality of users.

2. The vehicle communication device according to claim 1, wherein
the information creation unit creates common information indicating an item common to the plurality of users by comparing the pieces of personal information of the plurality of users.

3. The vehicle communication device according to claim 1, wherein
the information creation unit creates compatibility information indicating compatibility between the plurality of users based on a relationship between the pieces of personal information of the plurality of users.

4. The vehicle communication device according to claim 3, wherein
the information creation unit creates the compatibility information based on the pieces of personal information of the plurality of users and pieces of biological information of the plurality of users acquired by the wearable terminals.

5. A vehicle communication system comprising:
a plurality of wearable terminals worn by a plurality of users;
a detection unit that detects presence of the plurality of wearable terminals in a vehicle when the plurality of users ride on the vehicle;
an information creation unit that creates information related to the plurality of users based on pieces of personal information of the plurality of users held by the wearable terminal; and
an information display unit that displays the information created by the information creation unit on the wearable terminals worn by the plurality of users.
